(19) United States
(12) Patent Application Publication
(10) Pub. No.: US 2013/0089639 A1
(43) Pub. Date: Apr. 11, 2013

(54) Low Glycaemic Index Baked Product Comprising High Levels of Fibre, Proteins and Inclusions

(71) Applicants: Véronique Pêtre, Ceroux-Mousty (BE); Francoise Del Turco, Lasne (BE)

(72) Inventors: Véronique Pêtre, Ceroux-Mousty (BE); Francoise Del Turco, Lasne (BE)

(73) Assignee: Puratos N.V., Groot-Bijgaarden (BE)

(21) Appl. No.: 13/378,723

(22) PCT Filed: Jul. 15, 2010
(86) PCT No.: PCT/EP2010/060182

§ 371 Date: Mar. 15, 2012

(30) Foreign Application Priority Data
Jul. 17, 2009 (EP) 09165815.3

(51) Int. Cl. A21D 13/06

(52) U.S. Cl. CPC A21D 13/06
USPC 426/62; 426/549; 426/555; 426/496; 426/61; 426/311

(57) ABSTRACT

The present invention is directed to a bread product which is particularly adapted for breakfast, and which is characterized by high satietogenic and nutritional properties, and its convenience of use. Said bread product comprises 8-25 wt % of proteins, more than 6 wt % of fibres and 18-35 wt % of inclusions having an average size of at least 2 mm.

### FIELD OF THE INVENTION

The present invention relates generally to baked products. More particularly, the present invention is directed to a bread product which is particularly adapted for breakfast, and which is characterized by high satietogenic and nutritional properties, and its convenience of use.

### BACKGROUND OF THE INVENTION

The number of skipped breakfast occasions continues to rise across the world, despite awareness of health benefits associated with breakfast. In year 2007 for example, the average European skipped 66 breakfasts, the forecast being 70 breakfasts by 2012. Time scarcity and a lack of hunger are the main reasons cited for skipping breakfast. Actually, a surprising proportion of consumers still believe skipping breakfast is an effective way to lose weight.

At home, breakfast occasions are declining as consumers opt to eat breakfast on-the-move and at work more frequently. In an attempt to save time, the importance of the on-the-move or at-work breakfast will continue to grow especially with the added pressure associated with recession and the need to work potentially longer days. In particular, younger consumers (18-34 years old) have an increased propensity to skip breakfast mainly because of a more pressured working environment and desire to free time from food preparation. A lack of time in the morning means that consumers are most likely to opt for breakfast items that are quick and easy to prepare.

Although breakfast may be characterized by convenience and routine, consumers are still reluctant to compromise the sensory attributes associated with a morning meal, such as fresh and tasty ingredients. Accordingly, some people have opted for products such as croissants, pastries, cookies, brownies, muffins, or cakes which may be consumed on the way to the work (in public transportation means or in the car) or at the working place. Although these products provide for an immediate satiety effect and are convenient to use (they may be consumed on-the-go, e.g. on the way to the work or at the working place), their satietogenic effect is not prolonged enough. A large proportion of consumers feel then hungry soon after these products are ingested and tend to nibble between meals. The consequences of such bad eating habits may be dramatic for health, and may contribute to obesity and many of the chronic diseases such as diabetes, coronary heart diseases, stroke and certain cancers.

Other products currently available are the so-called breakfast biscuits or cereal bars. Without denying their reasonable energy content and their pretty fair satietogenic effect, these products tend to be perceived by some people as less authentic than bread-like products (mainly due to their much lower water content) and therefore less appropriate for breakfast. Actually, a significant proportion of consumers ask for more traditional bread-type breakfast products, i.e. possessing quality characteristics which are typical for bread (such as texture, flavor, density and nutrition). In the same time, and due to health concerns, there is an increasing demand for healthier products (i.e. with less fat content and low calorie load).

A healthy and equilibrated breakfast is characterized by energy content between 200 and 380 kcal and by its satietogenic effect. Previous attempts at developing healthy bread products are know in the art. FR-A1-2 887 406 discloses a baked product enriched in fibres. WO 2005/077207 describes a dietetic bread with high content of proteins and lipids, and which is claimed to provide improved satiety effect. WO 2007/056802 describes a lowered glycemic index white bread product. Without contesting the advantages associated with the products disclosed in the art, those generally suffer from poor textures, unpleasant tastes or unappealing appearance. The lack of appealing taste, flavor and pronounced organoleptic properties are the main disadvantages of these products.

In order to deliver a good taste and more intense organoleptic properties, (white) bread usually requires the addition of fat or other toppings, such as marmalade, honey or chocolate paste. However, these additional ingredients are generally known to disadvantageously affect the nutritional balance or the overall content of the bread product. In addition, a bread product associated with such toppings is typically inappropriate for a consumption on-the-go and is generally limited to home use.

There is therefore still a need for a ready-to-eat bread-type product which provides durable satiety effect and which is suitable for consumption on-the-go.

Other advantages and properties of the bread-type product according to the present invention will be apparent from the following description.

### SUMMARY OF THE INVENTION

In one aspect, the present invention relates to a bread product comprising:
a) from (about) 8 wt/wt % to (about) 25 wt/wt % of proteins;
b) more than (about) 6 wt/wt % of fibres, and
c) from (about) 18 wt/wt % to (about) 35 wt/wt % of inclusions having an average size of at least (about) 2 mm,
   wherein the percentages are expressed in weight by weight of the (final) bread product.

Preferably, in a bread product according to the invention, the inclusions have an average size of at least (about) 3 mm, more preferably at least (about) 4 mm. Preferably, in a bread product according to the invention, the inclusions have an average size which does not exceed (about) 10 mm. Preferably still, in a bread product according to the invention, the inclusions do not originate from the flour used to prepare the bread product. Preferably also, in a bread product according to the invention, the inclusions are selected from the group consisting of fresh or dried fruits, fresh or dried fruit pieces, grains, seeds, broken seeds, chocolate pieces, nuts, vegetables, vegetable pieces, and combinations thereof.

According to another preferred aspect, in a bread product according to the invention, the inclusions comprise (or consist of) fresh or dried fruit pieces preferably selected from the group consisting of apricots, raisins, figs, dates, prunes, and combinations thereof. More preferably, in a bread product according to the invention, the inclusions comprise (or consist of) dried fruit pieces preferably selected from the group consisting of apricots, raisins, figs, dates, prunes, and combinations thereof.

In yet another preferred aspect, the bread product according to the invention comprises:
a) from (about) 10 wt/wt % to (about) 20 wt/wt %, preferably from (about) 13 wt/wt % to (about) 20 wt/wt %, more preferably from (about) 15 wt/wt % to (about) 18 wt/wt % of proteins;
b) more than (about) 8 wt/wt %, preferably more than (about) 13 wt/wt %, more preferably from (about) 8 wt/wt % to (about) 25 wt/wt %, even more preferably from (about) 10 wt/wt % to (about) 20 wt/wt %, most preferably from (about) 13 wt/wt % to (about) 20 wt/wt % of fibres;
c) from (about) 20 wt/wt % to (about) 35 wt/wt %, preferably from (about) 20 wt/wt % to (about) 30 wt/wt %, more preferably from (about) 20 wt/wt % to (about) 25 wt/wt % of inclusions as above-described.

Preferably, in a bread product according to the invention, the fibres are selected from the group consisting of soluble fibres, insoluble fibres, and mixtures thereof. More preferably, the fibres for use herein are selected from the group consisting of starches, resistant starches, beta glucans, dextrins, maltodextrins, branched maltodextrins, pyrodextrines, polydextroses, inulins, oligosaccharides, fibres from plant origin (such as e.g. those derived from wheat, pea, lupin, and bean), and mixtures thereof.

Preferably, in a bread product according to the invention, the proteins are selected from the group consisting of proteins of plant origin, proteins derived from cereals, proteins of animal origin, and mixtures thereof. More preferably, proteins for use in the bread product of the invention are selected from the group consisting of (wheat) gluten, hydrolyzed (wheat) gluten, and mixtures thereof. Even more preferably, proteins for use in the bread product of the invention comprise a mixture of (wheat) gluten and hydrolyzed (wheat) gluten.

Typically, the bread product according to the invention further comprises preferably from (about) 25 wt/wt % to (about) 50 wt/wt %, more preferably from (about) 25 wt/wt % to (about) 40 wt/wt %, even more preferably from (about) 30 wt/wt % to (about) 40 wt/wt %, yet more preferably from (about) 30 wt/wt % to (about) 35 wt/wt % of flour. Typically also, the bread product of the invention further comprises preferably from (about) 25 wt/wt % to (about) 50 wt/wt %, more preferably from (about) 25 wt/wt % to (about) 45 wt/wt %, even more preferably from (about) 25 wt/wt % to (about) 40 wt/wt % of water. Preferably, the bread product of the invention further comprises from (about) 1 wt/wt % to (about) 3 wt/wt %, preferably from (about) 1 wt/wt % to (about) 2 wt/wt %, more preferably (about) 2 wt/wt % of yeast.

Preferably, in a bread product according to the invention, the flour comprises (or consists of) cereal flours. More preferably, the flour for use in a bread product according to the invention is selected from the group consisting of wheat flour, whole wheat flour, complete (wheat) flour, (whole) oat flour, (whole) spelt flour, and mixtures thereof. Even more preferably, the flour for use in a bread product according to the invention is selected from the group consisting of wheat flour, whole wheat flour, complete wheat flour, and mixtures thereof.

According to another preferred aspect, the bread product according to the invention advantageously further comprises from (about) 2 wt/wt % to (about) 10 wt/wt %, preferably from (about) 2 wt/wt % to (about) 7 wt/wt %, more preferably from (about) 3 wt/wt % to (about) 5 wt/wt % of optional ingredients, which are preferably compounds intended to provide enhanced organoleptic properties to the resulting bread product of the invention. Such optional ingredients for use in the bread according to the invention are preferably selected from the group consisting of salt (e.g. preferably iodized salt), stabilizers (e.g. preferably guar gum), fat, emulsifiers, oxidizing agents (e.g. preferably vitamin C), reducing agents (e.g. preferably cysteine), antioxidants, enzymes, flavouring agents such as e.g. sourdough, flour treatment agents, vitamins, minerals, sweeteners, sugars, eggs, milk or milk derivatives, and mixtures thereof.

In still another preferred aspect, the bread product according to the invention comprises:
a) from (about) 10 wt/wt % to (about) 20 wt/wt %, preferably from (about) 13 wt/wt % to (about) 20 wt/wt %, more preferably from (about) 15 wt/wt % to (about) 18 wt/wt % of proteins;
b) more than (about) 8 wt/wt %, preferably more than (about) 13 wt/wt %, more preferably from (about) 8 wt/wt % to (about) 25 wt/wt %, even more preferably from (about) 10 wt/wt % to (about) 20 wt/wt %, most preferably from (about) 13 wt/wt % to (about) 20 wt/wt % of fibres;
c) from (about) 20 wt/wt % to (about) 35 wt/wt %, preferably from (about) 20 wt/wt % to (about) 30 wt/wt %, more preferably from (about) 20 wt/wt % to (about) 25 wt/wt % of inclusions as above-described;
d) from (about) 25 wt/wt % to (about) 50 wt/wt %, preferably from (about) 25 wt/wt % to (about) 40 wt/wt %, more preferably from (about) 30 wt/wt % to (about) 40 wt/wt %, even more preferably from (about) 30 wt/wt % to (about) 35 wt/wt % of flour;
e) from (about) 25 wt/wt % to (about) 50 wt/wt %, preferably from (about) 25 wt/wt % to (about) 45 wt/wt %, more preferably from (about) 25 wt/wt % to (about) 40 wt/wt % of water;
f) optionally (but preferably), from (about) 1 wt/wt % to (about) 3 wt/wt %, preferably from (about) 1 wt/wt % to (about) 2 wt/wt %, more preferably (about) 2 wt/wt % of yeast; and
g) optionally (but preferably), from (about) 2 wt/wt % to (about) 10 wt/wt %, preferably from (about) 2 wt/wt % to (about) 7 wt/wt %, more preferably from (about) 3 wt/wt % to (about) 5 wt/wt % of optional ingredients.

Preferably, a bread product of the invention has a fat content below (about) 11 wt/wt %, more preferably below (about) 9 wt/wt %, even more preferably below (about) 7 wt/wt %. Preferably also, a bread product of the invention has an energy content comprised between (about) 200 kcal and (about) 300 kcal, more preferably of (about) 260 kcal per 100 g of the bread product.

Preferably still, a bread product of the invention has a glycemic index of less than (about) 60, preferably of less than (about) 55, more preferably of less than (about) 50, even more preferably of less than (about) 45, when the glycemic index is measured according to the experimental protocol as described hereinafter.

In another aspect of the invention, it is provided a dry mix composition suitable for the preparation of a bread product, wherein the composition comprises (or consists of):
a) from (about) 10 wt/wt % to (about) 40 wt/wt % of proteins;
b) more than (about) 8 wt/wt % of fibres;
c) from (about) 25 wt/wt % to (about) 50 wt/wt % of inclusions having an average size of at least (about) 2 mm; and
d) from (about) 35 wt/wt % to (about) 70 wt/wt % of flour;
   wherein the composition comprises at least (about) 70 wt/wt % of dry matter, and wherein the percentages are expressed in weight by weight of the dry mix composition. More preferably, the dry mix composition of the invention comprises at least (about) 75 wt/wt %, more preferably at least (about) 80 wt/wt % of dry matter, wherein the percentages are expressed in weight by weight of the dry mix composition.

Preferably, a dry mix composition according to the invention comprises (or consists of):
a) from (about) 15 wt/wt % to (about) 35 wt/wt %, preferably from (about) 20 wt/wt % to (about) 30 wt/wt %, more preferably from (about) 21 wt/wt % to (about) 26 wt/wt % of proteins;
b) more than (about) 11 wt/wt %, preferably from (about) 11 wt/wt % to (about) 36 wt/wt %, more preferably from (about) 14 wt/wt % to (about) 29 wt/wt %, most preferably from (about) 18 wt/wt % to (about) 29 wt/wt % of fibres;
c) from (about) 28 wt/wt % to (about) 50 wt/wt %, preferably from (about) 28 wt/wt % to (about) 43 wt/wt %, more preferably from (about) 28 wt/wt % to (about) 36 wt/wt % of inclusions as above-described; and
d) from (about) from (about) 35 wt/wt % to (about) 57 wt/wt %, preferably from (about) 43 wt/wt % to (about) 57 wt/wt %, more preferably from (about) 43 wt/wt % to (about) 50 wt/wt % of flour;
   wherein the inclusions preferably have an average size of at least (about) 3 mm, more preferably at least (about) 4 mm. Preferably, in a dry mix composition according to the invention, the inclusions have an average size which does not exceed (about) 10 mm. Preferably still, in a dry mix composition according to the invention, the inclusions do not originate from the flour.

Preferably, in a dry mix composition of the invention, the inclusions are selected from the group consisting of fresh or dried fruits, fresh or dried fruit pieces, grains, seeds, broken seeds, chocolate pieces, nuts, vegetables, vegetable pieces, and combinations thereof. More preferably, the inclusions comprise fresh or dried fruit pieces preferably selected from the group consisting of apricots, raisins, figs, dates, prunes, and combinations thereof. More preferably, in a dry mix composition according to the invention, the inclusions comprise (or consist of) dried fruit pieces preferably selected from the group consisting of apricots, raisins, figs, dates, prunes, and combinations thereof.

According to another preferred aspect, the dry mix composition according to the invention advantageously further comprises from (about) 3 wt/wt % to (about) 14 wt/wt %, preferably from (about) 3 wt/wt % to (about) 10 wt/wt %, more preferably from (about) 4 wt/wt % to (about) 7 wt/wt % of optional ingredients, which are preferably compounds intended to provide enhanced organoleptic properties to the resulting bread product of the invention. Such optional ingredients for use in the dry mix composition according to the invention are preferably selected from the group consisting of salt (e.g. preferably iodized salt), stabilizers (e.g. preferably guar gum), fat, emulsifiers, leavening agent (e.g. yeast or chemical leavening agent), oxidizing agents (e.g. preferably vitamin C), reducing agents (e.g. preferably cysteine), antioxidants, enzymes, flavouring agents such as e.g. sourdough, flour treatment agents, vitamins, minerals, sweeteners, sugars, eggs, milk or milk derivatives, fat, and mixtures thereof.

According to still another aspect of the present invention, it is provided a concentrated dry mix composition suitable for the preparation of a bread product, wherein said composition comprises (or consists of):
a) from (about) 15 wt/wt % to (about) 53 wt/wt % of proteins;
b) more than (about) 13 wt/wt % of fibres;
c) from (about) 40 wt/wt % to (about) 78 wt/wt % of inclusions having an average size of at least (about) 2 mm; and
d) from (about) 17 wt/wt % to (about) 35 wt/wt % of flour;
   wherein the composition comprises at least (about) 70 wt/wt % of dry matter, and wherein the percentages are expressed in weight by weight of the concentrated dry mix composition. More preferably, the dry mix composition of the invention comprises at least (about) 75 wt/wt %, more preferably at least (about) 80 wt/wt % of dry matter, wherein the percentages are expressed in weight by weight of the concentrated dry mix composition.

Preferably, a concentrated dry mix composition according to the invention comprises (or consists of):
a) from (about) 20 wt/wt % to (about) 42 wt/wt %, preferably from (about) 26 wt/wt % to (about) 42 wt/wt %, more preferably from (about) 31 wt/wt % to (about) 38 wt/wt % of proteins;
b) more than (about) 17 wt/wt %, preferably from (about) 17 wt/wt % to (about) 55 wt/wt %, more preferably from (about) 22 wt/wt % to (about) 44 wt/wt %, most preferably from (about) 29 wt/wt % to (about) 44 wt/wt % of fibres;
c) from (about) 44 wt/wt % to (about) 78 wt/wt %, preferably from (about) 44 wt/wt % to (about) 67 wt/wt %, more preferably from (about) 44 wt/wt % to (about) 56 wt/wt % of inclusions as above-described; and
d) from (about) 17 wt/wt % to (about) 28 wt/wt %, preferably from (about) 21 wt/wt % to (about) 29 wt/wt %, more preferably from (about) 21 wt/wt % to (about) 25 wt/wt % of flour;
   wherein the inclusions preferably have an average size of at least (about) 3 mm, more preferably at least (about) 4 mm. Preferably, in a concentrated dry mix composition according to the invention, the inclusions have an average size which does not exceed (about) 10 mm. Preferably still, in a concentrated dry mix composition according to the invention, the inclusions do not originate from the flour.

Preferably, in a concentrated dry mix composition of the invention, the inclusions are selected from the group consisting of fresh or dried fruits, fresh or dried fruit pieces, grains, seeds, broken seeds, chocolate pieces, nuts, vegetables, vegetable pieces, and combinations thereof. More preferably, the inclusions comprise fresh or dried fruit pieces preferably selected from the group consisting of apricots, raisins, figs, dates, prunes, and combinations thereof. More preferably, in a concentrated dry mix composition according to the invention, the inclusions comprise (or consist of) dried fruit pieces preferably selected from the group consisting of apricots, raisins, figs, dates, prunes, and combinations thereof.

According to another preferred aspect, the concentrated dry mix composition according to the invention advantageously further comprises from (about) 4 wt/wt % to (about) 20 wt/wt %, preferably from (about) 4 wt/wt % to (about) 16 wt/wt %, more preferably from (about) 6 wt/wt % to (about) 11 wt/wt % of optional ingredients, which are preferably compounds intended to provide enhanced organoleptic properties to the resulting bread product of the invention. Such optional ingredients for use in the concentrated dry mix composition according to the invention are preferably selected from the group consisting of salt (e.g. preferably iodized salt), stabilizers (e.g. preferably guar gum), fat, emulsifiers, leavening agent (e.g. yeast or chemical leavening agent), oxidizing agents (e.g. preferably vitamin C), reducing agents (e.g. preferably cysteine), antioxidants, enzymes, flavouring agents such as e.g. sourdough, flour treatment agents, vitamins, minerals, sweeteners, sugars, eggs, milk or milk derivatives, fat, and mixtures thereof.

In another aspect, the present invention relates to a method for the preparation of a bread product, the method comprising (or consisting of) the steps of:
a) mixing dough ingredients comprising:
   flour, preferably in amount from (about) 25 wt/wt % to (about) 50 wt/wt %;
   water, preferably in amount from (about) 30 wt/wt % to (about) 50 wt/wt %;
   from (about) 8 wt/wt % to (about) 25 wt/wt % of proteins preferably from (about) 10 wt/wt % to (about) 20 wt/wt % of proteins;
   more than (about) 6 wt/wt % of fibres, preferably from (about) 8 wt/wt % to (about) 25 wt/wt % of fibres;
   from (about) 18 wt/wt % to (about) 35 wt/wt % of inclusions having an average size of at least (about) 2 mm, preferably at least (about) 3 mm, more preferably at least (about) 4 mm;
   optionally (but preferably), a leavening agent;
   optionally (but preferably), optional ingredients;
so as to form a dough;
b) optionally (but preferably), kneading the dough;
c) optionally (but preferably), raising the dough; and
d) baking the dough so as to obtain the bread product;
   wherein the percentages are expressed in weight by weight of the (final) bread product, and wherein the optional ingredients are preferably selected from the group consisting of salt (e.g. preferably iodized salt), stabilizers (e.g. preferably guar gum), fat, emulsifiers, oxidizing agents (e.g. preferably vitamin C), reducing agents (e.g. preferably cysteine), antioxidants, enzymes, flavouring agents such as e.g. sourdough, flour treatment agents, vitamins, minerals, sweeteners, sugars, eggs, milk or milk derivatives, and mixtures thereof. Preferably, in a method for the preparation of a bread product according to the invention, the inclusions do not originate from the flour.

In still another aspect of the present invention, it is provided a method for the preparation of a bread product, the method comprising (or consisting of) the steps of:
a) mixing a dry mix composition or a concentrated dry mix composition as above-described with (optionally) flour and water, and optionally (but preferably) a leavening agent so as to form a dough;
b) optionally (but preferably), kneading the dough;
c) optionally (but preferably), raising the dough; and
d) baking the dough so as to obtain the bread product.

According to a preferred aspect of the method of the invention for the preparation of a bread product, the method comprises the steps of mixing a concentrated dry mix composition as above-described with: from (about) 17 wt/wt % to (about) 35 wt/wt % of flour; from (about) 30 wt/wt % to (about) 50 wt/wt % of water; from (about) 1 wt/wt % to (about) 3 wt/wt % of yeast; and optionally from about 2 wt/wt % to about 10 wt/wt % of optional ingredients as above-described; so as to form a dough; wherein the percentages are expressed in weight by weight of the (final) bread product.

According to another aspect of the method of the invention for the preparation of a bread product wherein said dry mix composition comprises flour, the method comprises the steps of mixing a dry mix composition as above-described with: from (about) 30 wt/wt % to (about) 50 wt/wt % of water; from (about) 1 wt/wt % to (about) 3 wt/wt % of yeast; and optionally from about 2 wt/wt % to about 10 wt/wt % of optional ingredients as above-described; so as to form a dough; wherein the percentages are expressed in weight by weight of the (final) bread product.

According to the present invention, proteins, fibres, inclusions, flour, and other optional ingredients (as described above) for use in the bread product and/or in the dry mix composition and/or in the method of the present invention, are preferably identical or at least similar.

In still another aspect, the present invention relates to the use of a dry mix composition or a concentrated dry mix composition as above-described for preparing a bread product providing durable satiety effect and/or reduced glycemic index.

According to still another aspect, the present invention is directed to a bread product as above-described for use in the treatment or for the prevention of any of the pathologies selected from the group of obesity, diabetes, hypercholesterolemia, and any combinations thereof.

### BRIEF DESCRIPTION OF THE DRAWINGS

FIG. 1 is a graph showing the difference of feeling of hunger expressed by expert panelists at various periods in time, after eating a bread product according to the invention when compared to a reference product.

FIG. 2 illustrates the difference of food quantity consumed by expert panelists for lunch, after eating a bread product according to the invention when compared to a reference product.

FIG. 3 represents pictures of bread products according to the invention (3a) when compared to reference bread products (3b), i.e. not according to the invention.

FIG. 4 and FIG. 5 are graphs showing respectively the difference of hunger feeling and desire to eat expressed by expert panelists at various periods in time, after consuming a breakfast comprising a bread product according to the invention when compared to three breakfast types comprising other bread products.

### DETAILED DESCRIPTION OF THE INVENTION

In the following description, reference is made to the accompanying examples to form part hereof, and which how by way of illustration specific embodiments/aspects in which the invention may be practised. Embodiments/aspects are described in sufficient detail to enable those skilled in the art to fully practise the invention, and it is to be understood that other embodiments/aspects may be used.

The present invention discloses a convenient bread product, which is particularly adapted for breakfast, and which provides excellent satiety effect and nutritional benefits. A dry mix composition and a method suitable for the preparation of such bread are also described.

Satietogenic effect is generally referred to the ability to provide a feeling or impression of fullness that a person experiences after consuming a food item. Low satietogenic food items are generally considered to provide lesser sensation of fullness for a shorter time after a certain quantity of calories are consumed, whereas foods with higher satiety responses are generally considered to provide stronger sensation of fullness for a longer period after similar quantities of calories are consumed.

In a first aspect, the present invention relates to a bread product comprising:
a) from (about) 8 wt/wt % to (about) 25 wt/wt % of proteins;
b) more than (about) 6 wt/wt % of fibres, and
c) from (about) 18 wt/wt % to (about) 35 wt/wt % of inclusions having an average size of at least (about) 2 mm,
   wherein the percentages are expressed in weight by weight of the (final) bread product.

Throughout the description, the term “about” is meant to indicate that a deviation of preferably 10% around the indicated value is envisaged. Accordingly, about 20 preferably means every (integer or decimal) number comprised between 18 and 22.

In the context of the present invention, the term “bread product” is meant to refer to any product item which may be perceived by a consumer as similar (bread-like) or identical to bread (such as e.g. white bread). In particular, the term “bread product” according to the invention is meant to encompass any baked product based on (cereal) flour, regardless of its type, and which comprises a leavening agent (such as yeast or a chemical leavening agent). By “bread product”, it is alternatively meant a baked product which is yeast-raised or chemically-raised, and which preferably has a water content of more than 20 wt/wt %, more preferably more than 25 wt/wt % by weight of the bread product. Accordingly, the so-called “cereal bars”, “breakfast cereals” and “breakfast biscuits” are not meant to be within the scope of the present invention. The present invention may be also be referred to as bread-like product throughout the description.

In the context of the present invention, the term “inclusion” is meant to refer to any edible element/particle/object which may be incorporated in a bread product. Inclusions for use herein have an average size of at least (about) 2 mm. The expression “average size of the inclusion” is meant to refer to the average value of the greatest dimension of the inclusion. In the case of a spherical particle, the greatest dimension would be the diameter of said particle.

Typically, any edible element/particle/object originating from the flour shall not be considered as inclusions for use in the present invention. In particular, particles such as unprocessed, intact or broken cereal grains resulting from the milling process shall not be considered as inclusions for use in the context of the present invention. Examples of cereal grains comprise, but are not limited to, wheat, oat, spelt, rye, rice, corn (maize) or any combinations thereof.

Preferably, in a bread product according to the present invention, the inclusions have an average size of at least (about) 3 mm, more preferably at least (about) 4 mm. Preferably, in a bread product according to the invention, the inclusions have an average size which does not exceed (about) 10 mm.

Suitable inclusions for use herein may be easily identified by those skilled in the art. According to a preferred aspect of the bread product according to the invention, the inclusions are selected from the group consisting of fresh or dried fruits, fresh or dried fruit pieces, grains, seeds, broken seeds, chocolate pieces, nuts, vegetables, vegetable pieces, meat, meat pieces, bacon pieces, and combinations thereof. Examples of suitable of nut-type inclusions include, but are not limited to, hazelnuts, walnuts, almonds, cashews, pecans, and combinations thereof.

More preferably, the inclusions for use herein comprise (or consist of) fresh or dried fruit pieces preferably selected from the group consisting of apricots, raisins, figs, dates, prunes, and combinations thereof. Even more preferably, the inclusions for use herein comprise (or consist of) dried fruit pieces preferably selected from the group consisting of apricots, raisins, figs, dates, prunes, and combinations thereof.

In the context of the present invention, it has been surprisingly discovered that inclusions as defined above not only contribute in enhancing organoleptic properties (e.g. flavour) and/or texture of the final bread product, but also participate in increasing the nutritional value and the satietogenic effect of the bread product. In the context of the present invention, the Applicant was challenged to combine high levels of proteins and fibres and also high levels of inclusions while preserving quality characteristics which are typical for a bread-like product (aspect, texture, flavour, volume, density), and maintaining high organoleptic eating qualities in addition to excellent nutritional profile and satietogenic effect. This is unexpected result as the relative amount of flour used for the preparation of the bread product is necessarily decreased in direct proportion to the increases of the levels of proteins, fibres and inclusions. Advantageously, the bread product of the invention is ready-to-eat and is suitable for consumption on-the-go.

In yet another preferred aspect, the bread product according to the invention comprises:
a) from (about) 10 wt/wt % to (about) 20 wt/wt %, preferably from (about) 13 wt/wt % to (about) 20 wt/wt %, more preferably from (about) 15 wt/wt % to (about) 18 wt/wt % of proteins;
b) more than (about) 8 wt/wt %, preferably more than (about) 13 wt/wt %, more preferably from (about) 8 wt/wt % to (about) 25 wt/wt %, even more preferably from (about) 10 wt/wt % to (about) 20 wt/wt %, most preferably from (about) 13 wt/wt % to (about) 20 wt/wt % of fibres;
c) from (about) 20 wt/wt % to (about) 35 wt/wt %, preferably from (about) 20 wt/wt % to (about) 30 wt/wt %, more preferably from (about) 20 wt/wt % to (about) 25 wt/wt % of inclusions as above-described.

The bread product according to the present invention further comprises proteins. Any proteins suitable for use in the food industry, and in particular in bakery applications, may be used in the bread product according to the present invention, and more broadly speaking in the context of the present invention. Suitable proteins for use herein will be easily identified by those skilled in the art of bakery and bread products.

Preferably, in a bread product according to the invention, the proteins are selected from the group consisting of proteins of animal origin, proteins of plant origin, proteins derived from cereals, and mixtures thereof.

Animal protein sources, for use in a bread product according to the invention, may originate from eggs and eggs derivatives proteins, from milk and milk derivatives.

Plant protein sources may include soy protein, soy flour especially defatted soy meal, soy protein isolate, wheat zein, corn zein, and mixtures thereof. Generally speaking, and without wishing to be bound by theory, it is believed that the presence of proteins of plant origin, proteins derived from cereals or proteins of animal origin lead to improve the amount of proteins provided by the baked product of the invention while reducing even more the amount of fat, flour, and possibly milk products provided by the baked product. Furthermore, it is believed that these proteins increase the satietogenic properties of the baked product of the invention.

More preferably, proteins for use in the bread product of the invention are selected from the group of proteins derived from cereals, and more preferably from the group consisting of (wheat) gluten, hydrolyzed (wheat) gluten, and mixtures thereof. Even more preferably, proteins for use in the bread product of the invention comprise (consist of) a mixture of (wheat) gluten and hydrolyzed (wheat) gluten.

Determination of the overall protein amount comprised in a bread product according to the invention is well within the practice of those skilled in the art. Suitable official methodologies for protein determination (Kjeldahl combustion method) include, but are not limited to, AOAC Method 992.23 (Association of Official Analytical Chemists) and AACC Method 46-30, 1999 (American Association of Cereal Chemists).

The bread product according to the present invention further comprises fibres. Any fibres suitable for use the in food industry, and in particular in bakery applications, may be used in the bread product according to the present invention, and more broadly speaking in the context of the present invention. Suitable fibres for use herein will be easily identified by those skilled in the art of bakery and bread products.

It is well known that the presence of dietary fibres will lead to the bread product being digested slower, and thus increasing the amount of certain types of fibres can aid in decreasing the glycemic response (glycemic index) of the bread product by reducing the level of complexes carbohydrates by substitution of the flour and/or fat.

Without wishing to be bound by theory, it is believed that the presence of both the proteins and the fibres associated with a reduction of the glycemic response contributes to the high satietogenic effect of the bread product of the present invention.

Preferably, in a bread product according to the invention, the fibres are selected from the group consisting of soluble fibres (i.e. soluble in water), insoluble fibres, and mixtures thereof.

Suitable soluble fibres for use in the context of the present invention and more particularly for use in the bread product of the invention, comprise fructo-oligosaccharides (FOS), gluco-oligosaccharides (GOS), isomalto-oligosaccharides (IMO), trans-galacto-oligosaccharides (TOS), pullulan, and mixtures thereof.

More particularly, suitable soluble fibres for use herein comprise fructanes, FOS, inulins, dextrins, maltodextrins, branched maltodextrins, polydextroses, pyrodextrins, soluble oligosaccharides of oleaginous or proteaginous origin, and mixtures thereof.

More preferably, soluble fibres for use herein are advantageously selected from the group of dextrins, maltodextrins, inulins and mixtures thereof. Even more preferably, soluble fibres for use herein are dextrins, in particular wheat dextrins.

Sources of soluble fibres for use in the context of the present invention may be e.g. chosen among legumes (such as peas, soybeans or other beans), cereals (such as oat, rye, or barley), fruits (such as prunes, apples or bananas), vegetables (such as carrots, Jerusalem artichokes, potato or onions) and psyllium.

Suitable insoluble fibres for use in the context of the present invention and more particularly for use in the bread product of the invention, comprise starches, resistant starches (as described e.g. in U.S. Pat. No. 6,451,367 and US 2004/0234663), cereal fibres (e.g. preferably wheat), fruit fibres, vegetable fibres, legume fibres (e.g. preferably pea, bean, carrot, bamboo, lupin), and mixtures thereof. More preferably, insoluble fibres for use herein are advantageously selected from the group consisting of starches, resistant starches, wheat fibres, pea fibres, and mixtures thereof. Even more preferably, insoluble fibres for use herein comprise pea fibres, resistant starches, and mixtures thereof. Most preferably, insoluble fibres for use herein are pea fibres.

In a preferred aspect, the fibres for use herein comprise a mixture of soluble fibres and insoluble fibres. More preferably, fibres for use herein comprise dextrins, maltodextrins, inulins, starches, resistant starches, wheat fibres, pea fibres, and mixtures thereof. Even more preferably, fibres for use herein comprise a mixture of (wheat) dextrins and pea fibres.

Also preferably, the fibres for use herein are selected from the group consisting of starches, resistant starches, beta glucans, dextrins, maltodextrins, branched maltodextrins, pyrodextrins, polydextroses, inulins, oligosaccharides, fibres from plant origin (such as e.g. those derived from wheat, pea, lupin, and bean), and mixtures thereof.

The total amount of fibres comprised in the bread product of the invention may be determined by any suitable method well know to those skilled in the art. Examples of suitable methods include, but are not limited to, AOAC 991.43, AOAC 985.29, AOAC 2001.03 and AOAC 994.13. Alternatively, the total amount of fibres may be calculated using the fibre content of the individual ingredients used for the manufacture of the bread product of the invention.

Advantageously, in the bread product according to the invention, some proportion of the overall amount of proteins and/or fibres contained in the (final) bread product according to the invention originates from the inclusions and/or the flour as described herein.

Typically, the bread product according to the invention further comprises preferably from (about) 25 wt/wt % to (about) 50 wt/wt %, more preferably from (about) 25 wt/wt % to (about) 40 wt/wt %, even more preferably from (about) 30 wt/wt % to (about) 40 wt/wt %, yet more preferably from (about) 30 wt/wt % to (about) 35 wt/wt % of flour, wherein the percentages are expressed in weight by weight of the (final) bread product. Any flours commonly used the in food industry, and in particular in bakery applications, may be used in the bread product according to the present invention, and more broadly speaking in the context of the present invention. Suitable flours for use herein will be easily identified by those skilled in the art of bakery and bread products. Those comprise, but are not limited to, flours obtained from cereals such as wheat, oat, spelt, whole wheat, rye, rice, corn (maize), and mixtures thereof.

Preferably, in a bread product according to the invention, the flour comprises (or consists of) cereal flours. More preferably, the flour for use in a bread product according to the invention is selected from the group consisting of wheat flour, whole wheat flour, complete (wheat) flour, (whole) oat flour, (whole) spelt flour, and mixtures thereof. Even more preferably, the flour for use in a bread product according to the invention is selected from the group consisting of wheat flour, whole wheat flour, oat flour, spelt flour, and mixtures thereof. Most preferably, the flour for use in a bread product according to the invention comprises a mixture of wheat flour, whole wheat flour, oat flour and spelt flour.

Typically also, the bread product of the invention further comprises preferably from (about) 25 wt/wt % to (about) 50 wt/wt %, more preferably from (about) 25 wt/wt % to (about) 45 wt/wt %, even more preferably from (about) 25 wt/wt % to (about) 40 wt/wt % of water, wherein the percentages are expressed in weight by weight of the (final) bread product.

Preferably, the bread product of the invention further comprises from (about) 1 wt/wt % to (about) 3 wt/wt %, preferably from (about) 1 wt/wt % to (about) 2 wt/wt %, more preferably (about) 2 wt/wt % of a leavening agent (preferably yeast), wherein the percentages are expressed in weight by weight of the (final) bread product. Alternatively, the yeast may be replaced by any chemical leavening agent well known to those skilled in the art. Determination of the optimal amount of leavening agent required in a bread product of the invention is well within the practice of the skilled persons.

According to another preferred aspect, the bread product according to the invention advantageously further comprises from (about) 2 wt/wt % to (about) 10 wt/wt %, preferably from (about) 2 wt/wt % to (about) 7 wt/wt %, more preferably from (about) 3 wt/wt % to (about) 5 wt/wt % of optional ingredients, which are preferably compounds intended to provide enhanced organoleptic properties to the resulting bread product of the invention. Such optional ingredients for use in the bread according to the invention are preferably selected from the group consisting of salt (e.g. preferably iodized salt), stabilizers (e.g. preferably guar gum), fat, emulsifiers, oxidizing agents (e.g. preferably vitamin C), reducing agents (e.g. preferably cysteine), antioxidants, enzymes, flavouring agents such as e.g. sourdough, flour treatment agents, vitamins, minerals, sweeteners, sugars, eggs, milk or milk derivatives, and mixtures thereof.

In still another preferred aspect, the bread product according to the invention comprises:
a) from (about) 10 wt/wt % to (about) 20 wt/wt %, preferably from (about) 13 wt/wt % to (about) 20 wt/wt %, more preferably from (about) 15 wt/wt % to (about) 18 wt/wt % of proteins;
b) more than (about) 8 wt/wt %, preferably more than (about) 13 wt/wt %, more preferably from (about) 8 wt/wt % to (about) 25 wt/wt %, even more preferably from (about) 10 wt/wt % to (about) 20 wt/wt %, most preferably from (about) 13 wt/wt % to (about) 20 wt/wt % of fibres;
c) from (about) 20 wt/wt % to (about) 35 wt/wt %, preferably from (about) 20 wt/wt % to (about) 30 wt/wt %, more preferably from (about) 20 wt/wt % to (about) 25 wt/wt % of inclusions as above-described;
d) from (about) 25 wt/wt % to (about) 50 wt/wt %, preferably from (about) 25 wt/wt % to (about) 40 wt/wt %, more preferably from (about) 30 wt/wt % to (about) 40 wt/wt %, even more preferably from (about) 30 wt/wt % to (about) 35 wt/wt % of flour;
e) from (about) 25 wt/wt % to (about) 50 wt/wt %, preferably from (about) 25 wt/wt % to (about) 45 wt/wt %, more preferably from (about) 25 wt/wt % to (about) 40 wt/wt % of water;
f) optionally (but preferably), from (about) 1 wt/wt % to (about) 3 wt/wt %, preferably from (about) 1 wt/wt % to (about) 2 wt/wt %, more preferably (about) 2 wt/wt % of yeast; and
g) optionally (but preferably), from (about) 2 wt/wt % to (about) 10 wt/wt %, preferably from (about) 2 wt/wt % to (about) 7 wt/wt %, more preferably from (about) 3 wt/wt % to (about) 5 wt/wt % of optional ingredients.

The bread product obtained according to the invention may be characterized as a low fat content bread product. Preferably, a bread product of the invention has a fat content below (about) 11 wt/wt %, more preferably below (about) 9 wt/wt %, even more preferably below (about) 8 wt/wt %, most preferably below (about) 7 wt/wt %, wherein the percentages are expressed in weight by weight of the (final) bread product. Preferably also, a bread product of the invention has a fat content which does not exceed (about) 8 wt/wt %, wherein the percentages are expressed in weight by weight of the (final) bread product.

Preferably also, a bread product of the invention has an energy content comprised between (about) 200 kcal and (about) 300 kcal, more preferably of (about) 260 kcal per 100 g of the bread product. Advantageously, (about) 100 g of the bread product according to the invention perfectly matches the amount of calories/energy recommended by nutritionists for a product to be consumed at breakfast. Beneficially, the bread product of the invention provides the recommended calories/energy while providing a low glycemic response (glycemic index).

According to a preferred aspect of the invention, the bread product has a glycemic index (GI) of less than (about) 60, preferably of less than (about) 55, more preferably of less than (about) 50, even more preferably of less than (about) 45, when the glycemic index is measured according to the experimental protocol as described hereinafter. According to this preferred aspect of the invention, the bread product according to the present invention may be characterized as a low glycemic index bread product. The present invention provides therefore a healthy and nutritionally balanced bread product. The bread product of the present invention may also be characterized as a high satiety (index) bread product.

According to a less preferred aspect of the invention, and depending on the nature of the selected inclusions, the bread product according to the present invention may not be characterized as a low glycemic index bread product.

Advantageously, the bread product of the invention weights from (about) 50 g to (about) 250 g, preferably from (about) 75 g to (about) 150 g, more preferably from (about) 90 g to (about) 100 g, most preferably the bread product of the invention has a weight of (about) 100 g, when the bread product of the invention is provided in the form of an individual portion.

Alternatively, the bread product of the invention has a weight of more than (about) 100 g, when the bread product of the invention is provided in the form of a bulk product to be divisible at will.

In another aspect of the invention, it is provided a dry mix composition suitable for the preparation of a bread product, wherein the composition comprises (or consists of):
a) from (about) 10 wt/wt % to (about) 40 wt/wt % of proteins;
b) more than (about) 8 wt/wt % of fibres, and
c) from (about) 25 wt/wt % to (about) 50 wt/wt % of inclusions having an average size of at least (about) 2 mm,
   wherein the composition comprises at least (about) 70 wt/wt % of dry matter, and wherein the percentages are expressed in weight by weight of the dry mix composition.

More preferably, the dry mix composition of the invention comprises at least (about) 75 wt/wt %, more preferably at least (about) 80 wt/wt % of dry material, wherein the percentages are expressed in weight by weight of the dry mix composition.

Preferably, a dry mix composition according to the invention comprises (or consists of):
a) from (about) 15 wt/wt % to (about) 35 wt/wt %, preferably from (about) 20 wt/wt % to (about) 30 wt/wt %, more preferably from (about) 21 wt/wt % to (about) 26 wt/wt % of proteins;
b) more than (about) 11 wt/wt %, preferably from (about) 11 wt/wt % to (about) 36 wt/wt %, more preferably from (about) 14 wt/wt % to (about) 29 wt/wt %, most preferably from (about) 18 wt/wt % to (about) 29 wt/wt % of fibres;
c) from (about) 28 wt/wt % to (about) 50 wt/wt %, preferably from (about) 28 wt/wt % to (about) 43 wt/wt %, more preferably from (about) 28 wt/wt % to (about) 36 wt/wt % of inclusions as above-described; and
d) from (about) from (about) 35 wt/wt % to (about) 57 wt/wt %, preferably from (about) 43 wt/wt % to (about) 57 wt/wt %, more preferably from (about) 43 wt/wt % to (about) 50 wt/wt % of flour;
   and wherein the inclusions preferably have an average size of at least (about) 3 mm, more preferably at least (about) 4 mm. Preferably, in a dry mix composition according to the invention, the inclusions have an average size which does not exceed (about) 10 mm.

Preferably, in a dry mix composition of the invention, the inclusions are selected from the group consisting of fresh or dried fruits, fresh or dried fruit pieces, grains, seeds, broken seeds, chocolate pieces, nuts, vegetables, vegetable pieces, and combinations thereof. Examples of suitable of nut-type inclusions include, but are not limited to, hazelnuts, walnuts, almonds, cashews, pecans, and combinations thereof. More preferably, the inclusions comprise fresh or dried fruit pieces preferably selected from the group consisting of apricots, raisins, figs, dates, prunes, and combinations thereof. Even more preferably, in a dry mix composition according to the invention, the inclusions comprise (or consist of) dried fruit pieces preferably selected from the group consisting of apricots, raisins, figs, dates, prunes, and combinations thereof.

Advantageously, in the dry mix composition according to the invention, some proportion of the overall amount of proteins and/or fibres contained in the dry mix composition according to the invention originates from the inclusions as described hereinabove.

According to another preferred aspect, the dry mix composition according to the invention advantageously further comprises from (about) 3 wt/wt % to (about) 14 wt/wt %, preferably from (about) 3 wt/wt % to (about) 10 wt/wt %, more preferably from (about) 4 wt/wt % to (about) 7 wt/wt % of optional ingredients, which are preferably compounds intended to provide enhancing organoleptic properties to the resulting bread product of the invention. Such optional ingredients for use in the dry mix composition according to the invention are preferably selected from the group consisting of salt (e.g. preferably iodized salt), stabilizers (e.g. preferably guar gum), fat, emulsifiers, leavening agent (e.g. yeast or chemical leavening agent), oxidizing agents (e.g. preferably vitamin C), reducing agents (e.g. preferably cysteine), antioxidants, enzymes, flavouring agents such as e.g. sourdough, flour treatment agents, vitamins, minerals, sweeteners, sugars, eggs, milk or milk derivatives, fat, and mixtures thereof.

According to an alternative aspect, the amount of flour may be reduced in the dry mix composition in order to obtain a more concentrated composition. Accordingly, in another aspect, the present invention relates to a concentrated dry mix composition suitable for the preparation of a bread product, wherein said composition comprises (or consists of):
a) from (about) 15 wt/wt % to (about) 53 wt/wt % of proteins;
b) more than (about) 13 wt/wt % of fibres;
c) from (about) 40 wt/wt % to (about) 78 wt/wt % of inclusions having an average size of at least (about) 2 mm; and
d) from (about) 17 wt/wt % to (about) 35 wt/wt % of flour;
   wherein the composition comprises at least (about) 70 wt/wt % of dry matter, and wherein the percentages are expressed in weight by weight of the concentrated dry mix composition. More preferably, the dry mix composition of the invention comprises at least (about) 75 wt/wt %, more preferably at least (about) 80 wt/wt % of dry matter, wherein the percentages are expressed in weight by weight of the concentrated dry mix composition.

Preferably, a concentrated dry mix composition according to the invention comprises (or consists of):
a) from (about) 20 wt/wt % to (about) 42 wt/wt %, preferably from (about) 26 wt/wt % to (about) 42 wt/wt %, more preferably from (about) 31 wt/wt % to (about) 38 wt/wt % of proteins;
b) more than (about) 17 wt/wt %, preferably from (about) 17 wt/wt % to (about) 55 wt/wt %, more preferably from (about) 22 wt/wt % to (about) 44 wt/wt %, most preferably from (about) 29 wt/wt % to (about) 44 wt/wt % of fibres;
c) from (about) 44 wt/wt % to (about) 78 wt/wt %, preferably from (about) 44 wt/wt % to (about) 67 wt/wt %, more preferably from (about) 44 wt/wt % to (about) 56 wt/wt % of inclusions as above-described; and
d) from (about) 17 wt/wt % to (about) 28 wt/wt %, preferably from (about) 21 wt/wt % to (about) 29 wt/wt %, more preferably from (about) 21 wt/wt % to (about) 25 wt/wt % of flour;
   wherein the inclusions preferably have an average size of at least (about) 3 mm, more preferably at least (about) 4 mm. Preferably, in a concentrated dry mix composition according to the invention, the inclusions have an average size which does not exceed (about) 10 mm.

Preferably, in a concentrated dry mix composition of the invention, the inclusions are selected from the group consisting of fresh or dried fruits, fresh or dried fruit pieces, grains, seeds, broken seeds, chocolate pieces, nuts, vegetables, vegetable pieces, and combinations thereof. More preferably, the inclusions comprise fresh or dried fruit pieces preferably selected from the group consisting of apricots, raisins, figs, dates, prunes, and combinations thereof. More preferably, in a concentrated dry mix composition according to the invention, the inclusions comprise (or consist of) dried fruit pieces preferably selected from the group consisting of apricots, raisins, figs, dates, prunes, and combinations thereof.

According to another preferred aspect, the concentrated dry mix composition according to the invention advantageously further comprises from (about) 4 wt/wt % to (about) 20 wt/wt %, preferably from (about) 4 wt/wt % to (about) 16 wt/wt %, more preferably from (about) 6 wt/wt % to (about) 11 wt/wt % of optional ingredients, which are preferably compounds intended to provide enhanced organoleptic properties to the resulting bread product of the invention. Such optional ingredients for use in the concentrated dry mix composition according to the invention are preferably selected from the group consisting of salt (e.g. preferably iodized salt), stabilizers (e.g. preferably guar gum), fat, emulsifiers, leavening agent (e.g. yeast or chemical leavening agent), oxidizing agents (e.g. preferably vitamin C), reducing agents (e.g. preferably cysteine), antioxidants, enzymes, flavouring agents such as e.g. sourdough, flour treatment agents, vitamins, minerals, sweeteners, sugars, eggs, milk or milk derivatives, fat, and mixtures thereof.

However, the invention is not that limited. Other variations of concentrated dry mix compositions (i.e. comprising different amounts of flour, proteins, fibres and inclusions) are intended to be within the scope of the present invention. Suitable variations of concentrated dry mix compositions will be easily identified by those skilled in the art based on the teaching of the present disclosure.

Advantageously, a dry mix composition or a concentrated dry mix composition according to the invention is a ready-to-use dry mix composition to which only a required amount of water and (optionally) a leavening agent has to be added to form a dough suitable for the preparation of a bread product.

Advantageously still, a dry mix composition or a concentrated dry mix composition according to the invention may take the form of a dry powder and provides for long time storage stability. Preferably, a dry mix composition of the invention may be stored at room temperature (i.e. at about 25° C.), under standard humidity conditions for more than 6 months, preferably for more than 9 months, more preferably for more than 12 months, without significantly losing its intrinsic qualities/properties.

In still another aspect, the present invention relates to a method for the preparation of a bread product, the method comprising (or consisting of) the steps of:
a) mixing dough ingredients comprising (or consisting of):
   flour, preferably in an amount from (about) 25 wt/wt % to (about) 50 wt/wt %;
   water, preferably in an amount from (about) 30 wt/wt % to (about) 50 wt/wt %;
   from (about) 8 wt/wt % to (about) 25 wt/wt % of proteins, preferably from 10 wt/wt % to 20 wt/wt % of proteins;
   more than (about) 6 wt/wt % of fibres, preferably from (about) 8 wt/wt % to (about) 25 wt/wt % of fibres;
   from (about) 18 wt/wt % to (about) 35 wt/wt % of inclusions having an average size of at least (about) 2 mm, preferably at least (about) 3 mm, more preferably at least (about) 4 mm;
   optionally (but preferably), a leavening agent;
   optionally (but preferably), optional ingredients;
so as to form a dough;
b) optionally (but preferably), kneading the dough;
c) optionally (but preferably), raising the dough; and
d) baking the dough so as to obtain the bread product;
   wherein the percentages are expressed in weight by weight of the (final) bread product, and wherein the optional ingredients are preferably selected from the group consisting of salt (e.g. preferably iodized salt), stabilizers (e.g. preferably guar gum), fat, emulsifiers, oxidizing agents (e.g. preferably vitamin C), reducing agents (e.g. preferably cysteine), antioxidants, enzymes, flavouring agents such as e.g. sourdough, flour treatment agents, vitamins, minerals, sweeteners, sugars, eggs, milk or milk derivatives, and mixtures thereof.

In a preferred aspect, the method of the invention comprises the step of mixing dough ingredients comprising from (about) 1 wt/wt % to (about) 3 wt/wt %, preferably from (about) 1 wt/wt % to (about) 2 wt/wt %, more preferably (about) 2 wt/wt % of a leavening agent (preferably yeast), wherein the percentages are expressed in weight by weight of the (final) bread product.

In still another preferred aspect, the method of the invention comprises the step of mixing dough ingredients comprising from (about) 2 wt/wt % to (about) 10 wt/wt %, preferably from (about) 2 wt/wt % to (about) 7 wt/wt %, more preferably from (about) 3 wt/wt % to (about) 5 wt/wt % of optional ingredients as above-described, wherein the percentages are expressed in weight by weight of the (final) bread product.

A preferred method for the preparation of a bread product comprises (or consists of) the steps of:
a) mixing dough ingredients comprising:
   from (about) 30 wt/wt % to (about) 50 wt/wt % of flour;
   from (about) 10 wt/wt % to (about) 20 wt/wt % of proteins;
   from (about) 10 wt/wt % to (about) 20 wt/wt % of fibres;
   from (about) 20 wt/wt % to (about) 35 wt/wt % of inclusions as above-described;
   from (about) 30 wt/wt % to (about) 50 wt/wt % of water;
   from (about) 1 wt/wt % to (about) 2 wt/wt % of yeast;
   optionally, from (about) 3 wt/wt % to (about) 5 wt/wt % of optional ingredients;
so as to form a dough
b) optionally kneading the dough;
c) optionally (but preferably), raising the dough; and
d) baking the dough so as to obtain the bread product;
   wherein the percentages are expressed in weight by weight of the (final) bread product, and wherein the optional ingredients are preferably selected from the group consisting of salt (e.g. preferably iodized salt), stabilizers (e.g. preferably guar gum), fat, emulsifiers, oxidizing agents (e.g. preferably vitamin C), reducing agents (e.g. preferably cysteine), antioxidants, enzymes, flavouring agents such as e.g. sourdough, flour treatment agents, vitamins, minerals, sweeteners, sugars, eggs, milk or milk derivatives, and mixtures thereof.

In still another aspect of the present invention, it is provided a method for the preparation of a bread product, the method comprising (or consisting of) the steps of:
a) mixing a dry mix composition or a concentrated dry mix composition as above-described with (optionally) flour and water, and optionally (but preferably) a leavening agent so as to form a dough;
b) optionally (but preferably), kneading the dough;
c) optionally (but preferably), raising the dough; and
d) baking the dough so as to obtain the bread product.

According to a preferred aspect of the method of the invention for the preparation of a bread product, the method comprises the steps of mixing a concentrated dry mix composition as above-described with: from (about) 17 wt/wt % to (about) 35 wt/wt % of flour; from (about) 30 wt/wt % to (about) 50 wt/wt % of water; from (about) 1 wt/wt % to (about) 3 wt/wt % of yeast; and optionally from about 2 wt/wt % to about 10 wt/wt % of optional ingredients as above-described; so as to form a dough; wherein the percentages are expressed in weight by weight of the (final) bread product.

According to another aspect of the method of the invention for the preparation of a bread product, the method comprises the steps of mixing a dry mix composition as above-described with: from (about) 30 wt/wt % to (about) 50 wt/wt % of water; from (about) 1 wt/wt % to (about) 3 wt/wt % of yeast; and optionally from about 2 wt/wt % to about 10 wt/wt % of optional ingredients as above-described; so as to form a dough; wherein the percentages are expressed in weight by weight of the (final) bread product.

According to the present invention, proteins, fibres, inclusions, flour, and other optional ingredients (as described above) for use in the bread product of the invention and/or in the dry mix composition of the invention and/or in the methods of the present invention, are preferably identical or at least similar. Accordingly, proteins, fibres, inclusions, flour, and other optional ingredients (as described above) may be used interchangeably in the bread product of the invention, in the dry mix composition according to the invention and in the methods for the preparation of a bread product according to the invention. Also, in a preferred aspect of the invention, any (all, or some of the) preferences expressed with respect to proteins, fibres, inclusions, flour, and other optional ingredients (as described above) may be applied interchangeably in the bread product of the invention, in the dry mix composition according to the invention and in the methods for the preparation of a bread product according to the invention.

In still another aspect, the present invention relates to the use of a dry mix composition as above-described for preparing a bread product providing durable satietogenic effect and/or reduced glycemic index.

According to still another aspect, the present invention is directed to a bread product as above-described for use in the treatment or for the prevention of any of the pathologies selected from the group of obesity, diabetes, hypercholesterolemia, and any combinations thereof.

Advantageously, the bread product according to the invention is provided with excellent organoleptic properties (taste, flavor) and excellent softness, while facilitating the intestinal transit and a reduction of browsing/nibbling due to its high satietogenic capacities.

### EXAMPLES

### Example 1

Below are examples of compositions suitable for preparing bread products according to the invention. The following compositions are made comprising the listed ingredients in the listed proportions (% by weight). The examples herein are meant to exemplify the present invention but are not necessarily used to limit or otherwise define the scope of the present invention.

| Ingredients: | | | | | |
|---|---|---|---|---|---|
| (% by weight) | 1 | 2 | 3 | 4 | 5 |
| Flours (wheat, oat, | 29 | | 25 | | 29 |
| spelt) | | | | | |
| Flour (wheat) | | | | 29 | |
| Flour (wheat, oat) | | 29 | | | |
| Wheat gluten | 9 | 9 | 9 | 9 | 9 |
| Fibers (wheat, pea) | 7 | 7 | 7 | 7 | 7 |
| Dried fruit pieces | 20 | 20 | | 20 | 13 |
| (apricots, raisins) | | | | | |
| Dried fruit pieces | | | 20 | | |
| (raisins, figs, | | | | | |
| prunes) | | | | | |
| Chocolate grains | | | | | 6.8 |
| (average weight for | | | | | |
| 100 pieces: 9-11 g) | | | | | |
| Salt | 1.2 | 1.2 | 1.2 | 1.2 | 1.2 |
| Margarine | 2 | 2 | 2 | 2 | |
| Improver⁽*⁾ | 0.8 | 0.8 | 0.8 | 0.8 | 0.8 |
| Water | 29 | 29 | 29 | 29 | 30 |
| Yeast | 1.7 | 1.7 | 1.7 | 1.7 | 1.7 |

| | |
|---|---|
| Minors | Up to 100 |

^{(*)}Improver for use herein comprises: enzymes, emulsifiers, cysteine and vitamin C.

The above ingredients are mixed for about 6 minutes at slow speed in a spiral Ferneto mixer followed by about 5 minutes at high speed so as to form a dough. The dough is proofed at about 27° C. and allowed to ferment for about 10 minutes. Then pieces of about 110 g are cut and allowed to ferment for about 75 minutes at about 30° C. and under about 80% of room humidity. The baking is achieved at about 240-260° C. for about 9 minutes in a Miwe oven.

Bread products obtained according to the above recipe are provided with excellent organoleptic properties (taste, flavor), excellent softness, high satietogenic capacities and nutritional benefits.

### Example 2

Below is an example of a dry mix composition according to the present invention:

| Ingredients: | (% by weight) |
|---|---|
| Flours (wheat, oat, spelt) | 42 |
| Dried fruit pieces (Apricot, Raisins, Figs | 30 |
| and Plums) | |
| Wheat gluten | 13 |
| Fibers (pea, wheat) | 10.5 |
| Salt | 1.8 |
| Improver⁽*⁾ | 1.2 |
| Minors | Up to 100 |

^{(*)}Improver for use herein comprises: stabilizer, emulsifiers, dry wheat sourdough, cysteine and vitamin C.

### Example 3

A bread product according to the invention is made with the following ingredients in the listed proportions (% by weight):

| Ingredients: | (% by weight) |
|---|---|
| Dry mix composition | 67.3 |
| of Example 2 | |
| Water | 29.0 |
| Yeast | 1.7 |
| Margarine | 2.0 |

Working Method:

The ingredients are mixed for about 6 minutes in slow speed followed by about 5 minutes in high speed so as to form a dough. The dough is proofed at about 27° C. and allowed to ferment for about 10 minutes. Then pieces of 110 g are cut and allowed to ferment for about 75 minutes at about 30° C. and under about 80% of room humidity. The baking is achieved at about 240-260° C. for about 9 minutes. The bread product was tasted by a panel of expert people and was found very tasty, soft, practical and easy to eat.

### Example 4

### Satiety Test

A panel of 36 expert people was used to evaluate the satiety effect given by the bread product of Example 3. 18 persons received for 5 days a breakfast made of 100 g of a bread product of Example 3 and 250 ml orange juice. A control group received a breakfast made of 100 g white bread, 20 g jam and 250 ml orange juice. The amount of calories was similar in the two types of breakfast.

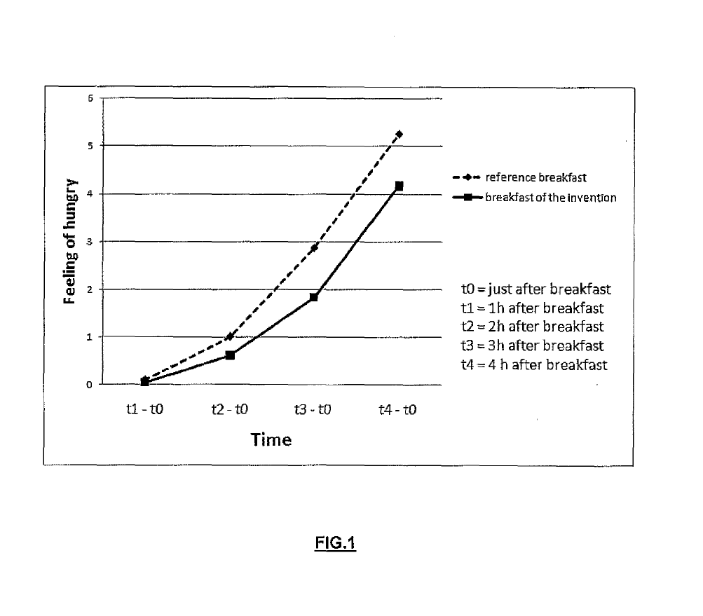

The feeling of hunger was evaluated using a six points rating scale (0 means extremely full, while 6 means extremely hungry) and the consumed food quantities for lunch were evaluated. The results (FIG. 1) show that people eating the bread product of the invention (Example 3) are significantly less hungry after four hours than people eating (white bread+jam).

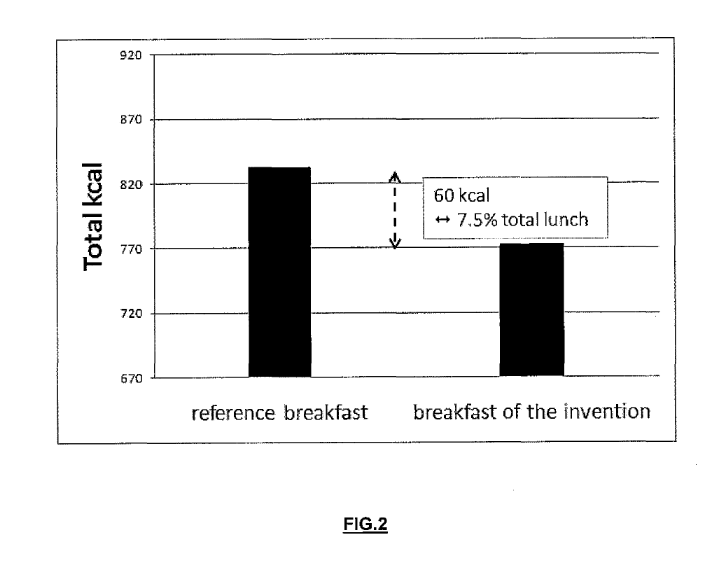

Additional results show that people eating the bread product of the invention (Example 3) eat less for lunch than people eating (white bread+jam). The mean calorie intake is about 7.5% lower (−60 kcal) per lunch (FIG. 2). It is known that a difference in consumption of −60 kcal equates to a weight reduction of about 3 kg in one year for an average person.

### Example 5

### Comparative Data

A bread product is made as described in example 1 with the following ingredients in the listed proportions (% by weight):

| Ingredients: | (% by weight) |
|---|---|
| Flour | 18.3 |
| Water | 20.3 |
| Wheat gluten | 10.0 |
| Fibers (wheat, pea) | 7.9 |
| Dried fruits | 37.0 |
| Salt | 1.2 |
| Margarine | 2 |
| Improver⁽*⁾ | 0.8 |
| Yeast | 1.7 |
| Minors | Up to 100 |

^{(*)}Improver for use herein comprises: enzymes, emulsifiers, cysteine and vitamin C.

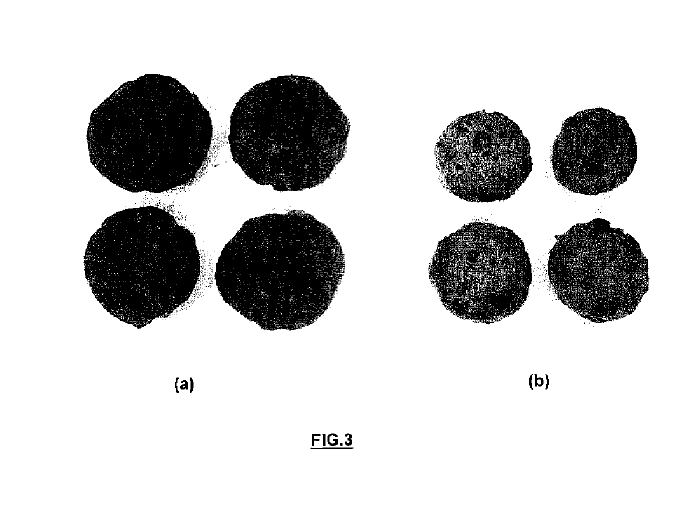

After baking, the resulting product (not according to the invention) shows a much smaller volume (FIG. 3b) when compared to a bread product obtained in Example 1 (FIG. 3a), i.e. according to the invention. The resulting product also lacks softness and does not taste fresh, according to the expert panelists.

### Example 6

### Glycemic Index

In the context of the present invention, the glycemic index of various bread products according to the invention are measured according to the following protocol.

Study Design:

Patients from 18 to 60 years were randomized. Exclusion criteria were the pregnancy or lactating mothers, persons having a Body Mass Index (BMI)≧30 kg/m², and medical conditions affecting appetite or glucose regulation. Ethics committees have given their approval.

### Calculation of GI:

The glycemic index was calculated from blood measurements taken at −5 min and at 0 min before consumption of the bread and at 15, 30, 45, 60, 90 and 120 minutes after starting to eat. Blood glucose is measured using HemoCue Glucose 201+ analyser (HemoCue® Ltd). Insulin is measured using the E411 Immunoassay Analyser (Roche Diagnostic, UK).

The incremental area under the blood glucose response curve (iAUC) is calculated geometrically, ignoring the area under the baseline. The iAUC for each test bread for each subject is expressed as a percentage of the mean iAUC for the reference food eaten by the same subject:

GI=(iAUC test food/iAUC reference food)×100

The glycemic index of each test is taken as the mean for the whole group.

In the context of the present invention, it has been surprisingly found that the glycemic index of some various bread products of the invention is significantly lower than the glycemic index of controls.

### Example 7

### Satiety Test

A panel of 28 expert people was used to evaluate the satiety effect given by a breakfast comprising the bread product of Example 3, when compared to three other breakfast types comprising other bread products: a white bread, a wholemeal bread and a wholegrain bread, as detailed in the table below.

| | A | B | C | D |
|---|---|---|---|---|
| Breakfast composition (g) | | | | |
| Bread according to example 3 | 100 | | | |
| White bread | | 100 | | |
| Wholemeal bread | | | 100 | |
| Wholegrain bread | | | | 100 |
| Fresh cheese | | 20 | 20 | 10 |
| Jam | | | 20 | 20 |
| Orange juice | 200 | 200 | 200 | 200 |
| $\frac{Bread content}{( \% by weight )}$ | | | | |
| Protein | 13 | 8 | 11 | 10 |
| Fibers | 11 | 2 | 7 | 6 |
| Dried fruit pieces | 22.4 | | | |
| $\frac{Bread {particles}^{(* )} content}{( \% by weight )}$ | | | | |
| Particles having an average | 20.8 | | 6.5 | |
| size of above 4 mm | | | | |
| Particles having an average | 1.0 | | 4.1 | |
| size comprised between | | | | |
| 3.15 and 4 mm | | | | |
| Particles having an average | 0.6 | | 4.2 | |
| size comprised between | | | | |
| 2 and 3.15 mm | | | | |
| Breakfast content | | | | |
| Protein (g) | 14 | 11 | 14 | 13 |
| Fat (g) | 5 | 5 | 5 | 6 |
| Carbohydrates (g) | 53 | 75 | 73 | 78 |
| Fibers (g) | 11 | 2 | 7 | 6 |
| Energy (kcal) | 381 | 407 | 404 | 401 |
| Energy density (kcal/g) | 1.27 | 1.27 | 1.19 | 1.21 |

^{(*)}In the case of bread product A, the term “particles” is meant to designate inclusions within the meaning of the present invention. In the case of bread product C however, the term “particles” is meant to refer to various particles originated from the flour, and this term may therefore not be referred to as inclusions within the meaning of the present invention.

The 28 expert people received one breakfast type for 3 consecutive days in a week. After 4 weeks all panelists had received all breakfast types.

The feeling of hunger and the desire to eat were evaluated using a ten points rating scale (0 means extremely full/no desire to eat, while 10 means extremely hungry/extreme desire to eat) and the consumed food quantities for lunch were evaluated.

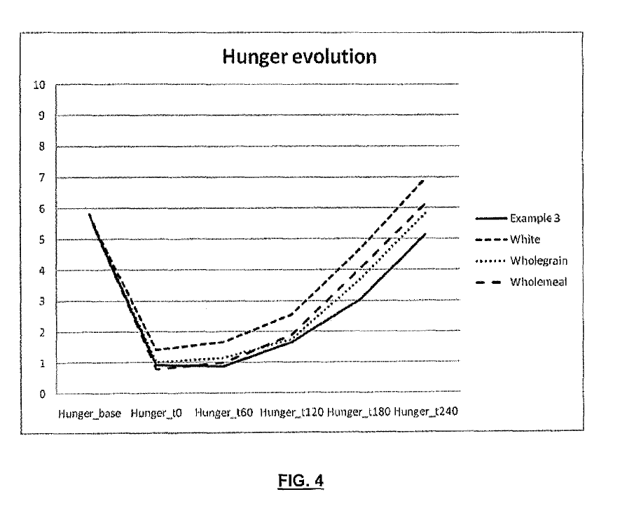

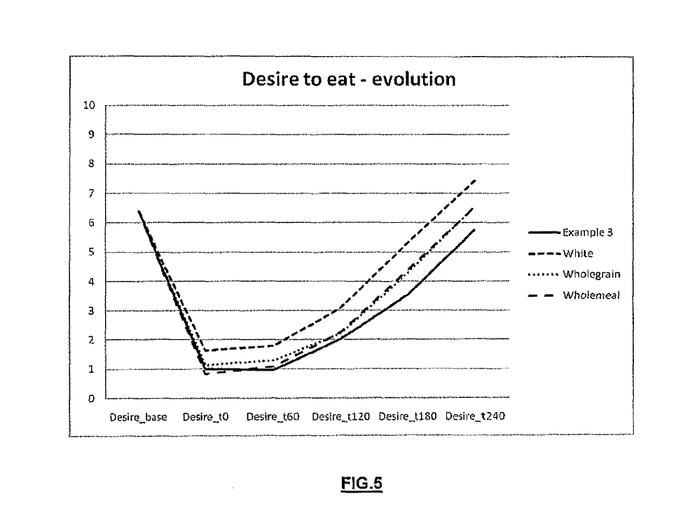

The results show that people eating the bread product of the invention (Example 3) are significantly less hungry after four hours than people eating any other proposed breakfast (FIG. 4) and that the desire to eat was also significantly lower (FIG. 5).

Additional results show that people eating the bread product of the invention (Example 3) eat less for lunch (855 kcal) than people eating a breakfast based on white bread (985 kcal) or wholegrain bread (919 kcal).

1. A bread product comprising:
a) from 8 wt/wt % to 25 wt/wt % of proteins;
b) more than 6 wt/wt % of fibres; and
c) from 18 wt/wt % to 35 wt/wt % of inclusions having an average size of at least 2 mm;
wherein the percentages are expressed in weight by weight of the bread product.

2. The bread product of claim 1, wherein said inclusions have an average size of at least 3 mm.

3. The bread product of claim 1, wherein said inclusions are selected from the group consisting of fresh or dried fruits, fresh or dried fruit pieces, grains, seeds, chocolate pieces, nuts, vegetables, vegetable pieces, and combinations thereof.

4. The bread product of claim 1, wherein said inclusions comprise fresh or dried fruit pieces selected from the group consisting of apricots, raisins, figs, dates, prunes, and combinations thereof.

5. The bread product of claim 1, comprising:
a) from 10 wt/wt % to 20 wt/wt % of proteins;
b) more than 8 wt/wt % of fibres; and
c) from 20 wt/wt % to 35 wt/wt % of inclusions.

6. The bread product of claim 1, further comprising: from 25 wt/wt % to 50 wt/wt %, of flour; from 25 wt/wt % to 50 wt/wt % of water; and from about 1 wt/wt % to about 3 wt/wt % of yeast.

7. The bread product of claim 1, wherein the bread product has a glycemic index of less than 60.

8. A dry mix composition suitable for the preparation of a bread product, comprising:
a) from 10 wt/wt % to 40 wt/wt % of proteins;
b) more than 8 wt/wt % of fibres;
c) from 25 wt/wt % to 50 wt/wt % of inclusions having an average size of at least 2 mm; and
d) from 35 wt/wt % to 70 wt/wt % of flour;
wherein said composition comprises at least 70 wt/wt %, of dry matter, and wherein the percentages are expressed in weight by weight of the dry mix composition.

9. The dry mix composition of claim 8, comprising:
a) from 15 wt/wt % to 35 wt/wt % of proteins;
b) more than 11 wt/wt % of fibres;
c) from 28 wt/wt % to 50 wt/wt % of inclusions; and
d) from 35 wt/wt % to 57 wt/wt % of flour;
wherein said inclusions have an average size of at least 3 mm.

10. A concentrated dry mix composition suitable for the preparation of a bread product, comprising:
a) from 15 wt/wt % to 53 wt/wt % of proteins;
b) more than 13 wt/wt % of fibres;
c) from 40 wt/wt % to 78 wt/wt % of inclusions having an average size of at least 2 mm; and
d) from 17 wt/wt % to 35 wt/wt % of flour;
wherein the composition comprises at least 70 wt/wt %, and wherein the percentages are expressed in weight by weight of the concentrated dry mix composition.

11. The concentrated dry mix composition of claim 10, comprising:
a) from 20 wt/wt % to 42 wt/wt % of proteins;
b) more than 17 wt/wt % of fibres;
c) from 44 wt/wt % to 78 wt/wt % of inclusions; and
d) from 17 wt/wt % to 28 wt/wt % of flour;
wherein the inclusions have an average size of at least 3 mm.

12. The dry mix composition of claim 8, wherein said inclusions are selected from the group consisting of fresh or dried fruits, fresh or dried fruit pieces, grains, seeds, chocolate pieces, nuts, vegetables, vegetable pieces, and combinations thereof.

13. A method for the preparation of a bread product, comprising:
mixing dough ingredients comprising:
from 30 wt/wt % to 50 wt/wt % of flour,
from 30 wt/wt % to 50 wt/wt % of water,
from 8 wt/wt % to 25 wt/wt % of proteins,
more than 6 wt/wt % of fibres,
from 18 wt/wt % to 40 wt/wt % of inclusions having an average size of at least 2 mm,
optionally, a leavening agent, and
optionally, optional ingredients,
so as to form a dough;
baking the dough so as to obtain said bread product; wherein the percentages are expressed in weight by weight of the final bread product, and wherein said optional ingredients are selected from the group consisting of salt, stabilizers, fat, emulsifiers, oxidizing agents, reducing agents, antioxidants, enzymes, flavouring agents, flour treatment agents, vitamins, minerals, sweeteners, sugars, eggs, milk or milk derivatives, and mixtures thereof.

14. A method for the preparation of a bread product, comprising:
mixing the dry mix composition of claim 8 with flour and water, and optionally a leavening agent so as to form a dough; and
baking the dough so as to obtain said bread product.

15. (canceled)

16. The bread product of claim 1, comprising:
a) from 13 wt/wt % to 20 wt/wt % of proteins;
b) more than 13 wt/wt % of fibres; and
c) from 20 wt/wt % to 30 wt/wt % of inclusions.

17. The bread product of claim 1, further comprising: from 25 wt/wt % to 40 wt/wt % of flour; from 25 wt/wt % to 45 wt/wt % of water; and from about 1 wt/wt % to about 2 wt/wt % of yeast.

18. The bread product of claim 1, further comprising: from 30 wt/wt % to 40 wt/wt % of flour; from 25 wt/wt % to 40 wt/wt % of water; and from about 1 wt/wt % to about 2 wt/wt % of yeast.

19. The bread product of claim 1, wherein the bread product has a glycemic index of less than 55.

20. The dry mix composition of claim 8, comprising:
a) from 20 wt/wt % to 30 wt/wt % of proteins;
b) from 11 wt/wt % to 36 wt/wt % of fibres;
c) from 28 wt/wt % to 43 wt/wt % of inclusions; and
d) from 43 wt/wt % to 57 wt/wt % of flour;
wherein the inclusions have an average size of at least 4 mm.

21. The concentrated dry mix composition of claim 10, comprising:
a) from 26 wt/wt % to 42 wt/wt % of proteins;
b) from 17 wt/wt % to 55 wt/wt % of fibres;
c) from 44 wt/wt % to 67 wt/wt % of inclusions; and
d) from 21 wt/wt % to 29 wt/wt % of flour;
wherein the inclusions have an average size of at least 4 mm.
